(19) United States
(12) Patent Application Publication
(10) Pub. No.: US 2016/0375358 A1
(43) Pub. Date: Dec. 29, 2016

(54) ARCADE GAME WITH CARD LIFTING MECHANISM

(71) Applicant: Stephen P. Shoemaker, JR., Redondo Beach, CA (US)

(72) Inventor: Stephen P. Shoemaker, JR., Redondo Beach, CA (US)

(21) Appl. No.: 14/956,290

(22) Filed: Dec. 1, 2015

Related U.S. Application Data
(63) Continuation-in-part of application No. 14/751,090, filed on Jun. 25, 2015.

(51) Int. Cl. A63F 9/30; G07F 17/32

(52) U.S. Cl. CPC A63F 9/30; G07F 17/3297

(57) ABSTRACT

An arcade target game uses an extraction device to remove a card or similar type prize from a housing. The cards are protected by an outer wall that limits successful attempts to those tries that avoid the wall. A vacuum source allows the extraction device to capture the prize if the extraction device successfully enters the tube. A displacement system is provided to lift the stack of cards in the game as they are depleted from playing the game.

### CROSS-REFERENCES TO RELATED APPLICATIONS

This application in a continuation-in-part of U.S. patent application Ser. No. 14/751,090, filed Jun. 25, 2015, incorporated by reference in its entirety.

### BACKGROUND OF THE INVENTION

Crane-type or “claw machine” arcade games are popular amusement devices often provided in game arcades, stores, or other public places. In these types of games, prize objects are provided within the game itself and are viewable by a player through transparent glass enclosure or the like. Upon the insertion of a coin or other monetary input into the game, the player controls a mechanical claw or extraction device with a joystick, buttons, toggle switch, or other control to maneuver the extraction device over a prize. The claw or extraction device is then lowered toward the prize upon activation either automatically by a controller such as a computer or manually by the player, depending on the particular game. The claw or extraction device is then either automatically opened when it reaches the level of the prizes or is opened under the player's control. After a predetermined amount of time, the claw may be automatically closed and elevated. Depending upon the claw's proximity and position with respect to the prize, the claw may or may not be able to grasp a prize and hold onto the prize as the claw is raised. The controller then moves the claw or extraction device over to a dispensing container and opens the claw, allowing the prize (if any is held) to drop into the dispensing chute and to be guided through the dispenser to an opening accessible to the player. In a common implementation, a sensor within the dispenser detects whether a prize has been won by the player. After the claw is opened over the dispenser, the controller moves the claw to its original starting position and waits for another insertion of the coin (unless the player is provided with multiple tries).

The prizes that the operator of a claw-type crane game can provide in the game are usually limited in selection due to the limitations of a mechanical claw. Since the claw must surround an object to be able to pick it up, most prizes in a claw-type crane game have been limited to plush animals, stuffed dolls, or other soft, rough-surfaced merchandise that can be surrounded and grabbed by the claw fingers and raised from the supporting surface. Usually, flat, smooth or thin objects are not able to be picked up and held by the claw. However, a large number of flat, smooth, and thin objects are desirable to used as prizes in a crane-type game, such as smooth-surfaced spheres or eggshell containers, boxes, gumballs, cups, bulbs, trading cards, etc. Players desire to win these types of items and operators desire to provide them; however, the standard claw type mechanism cannot be used to pick them up.

One solution to the inability of claw-type cranes to pick up these objects is to provide a different type of extraction device. One type of device that is used is a vacuum device that uses air suction to grab and hold an object. In U.S. Pat. No. 5,513,772 of Glaser (incorporated herein by reference in its entirety), a vacuum embodiment of a crane pick-up game is disclosed in which a vacuum motor is suspended from a string and concealed by a facade or enclosure. The player may move the motor and lower the motor towards a field of prizes similarly to the claw in claw-type crane games. A spinning fan within the motor creates a suction force that is used to pick up and hold prizes. An orifice with a screen is used to prevent items from being sucked into the orifice. Prizes captured and held by the suction are dispensed to the player through a dispenser.

More recent vacuum crane games have improved on the concept and made the game more challenging. In my U.S. Pat. No. 5,855,374 (also incorporated herein by reference in its entirety), a vacuum crane game is disclosed wherein the suction cup is used to pick up one of the prizes using a suction force that is provided by a vacuum pump coupled to the suction cup by a hose and located away from the vacuum head. Moving the pumping apparatus away from the crane head mechanism provides greater maneuverability than previous devices that carried the pumping equipment at the crane head. In general, the vacuum crane game is characterized by a vacuum extraction device positioned above the prize or target area and may be moved along a horizontal axis above the prize area. The extraction device includes a suction cup, a vacuum pump, and a vacuum head that may be raised and lowered toward a turntable in a z-direction. The suction cup is operative to pick up one of the prizes using a suction force that is provided by a vacuum pump coupled to the vacuum head by a hose. The vacuum pump is located away from the vacuum head to allow the vacuum head to move without interference. The player may control the movement of the extraction device to position the vacuum head over the prize area at a desired position, lower the vacuum head, and pick up a prize using the suction force. The extraction device is moved to a dispenser area and the suction force is removed, common with an electronic relief valve, to allow the prize to be dispensed to the player. The disclosure of my '374 patent is incorporated fully herein by reference. In another embodiment, the vacuum head may be moved in both x- and y-directions above the prize area and the turntable is omitted. Also, the vacuum can be created by a plunger type suction device, but a vacuum hose connection is preferable in some cases because disengagement is easily accomplished by turning off the vacuum to open an electronic relief valve.

With vacuum crane games, it is desirable to provide prizes having smooth continuous surfaces such that a seal can be formed by the suction cup against the prize. Without a seal, the suction cup cannot effectively apply suction to the prize sufficiently to enable the prize to be lifted out of the prize bin. As a consequence, prizes such as jewelry, candy, and toys are typically enclosed in transparent or opaque spheroids such as spheres and egg-shaped plastic containers. Such spheroids will have exteriors that meet the requirement of smooth, continuous surfaces allowing the vacuum head to make sealing contact. An example of this type of prize collection for a vacuum crane game can be found in my U.S. Pat. No. 6,598,881, entitled “Crane Game with Prize Redistribution Mechanism” and incorporated herein fully by reference.

The present inventor is also the sole inventor of a vacuum extraction device, U.S. Pat. No. 8,070,167, that required the crane to fit into a silo or receiving container before picking up the target. The difficulty of the game could be adjusted depending upon the size of the container and the length of projectiles that extended from the extraction device, making the margin for error smaller or larger depending upon the tolerances. The '167 Patent is incorporated fully herein by reference. The foregoing demonstrate some of the arcade type games credited to the present inventor. However, the advent of the vacuum crane has led to the ability to include prizes of higher value, which in turn attracts more customers and more profit for the owner of the games. However, with greater value prizes comes the need to more accurately control the win percentage of the games to prevent the games from being won too easily.

Plastic, cardboard, magnetic strip, NFC Tags (near field communication), laminated, and many other “gift cards” or “Valu-Cards™” have become a new kind of currency which has invaded the industry. These gift cards can be awarded as prizes for various purchases. These cards can then be redeemed by players for merchandise, and can be a valuable source of revenue for the supplier. First, in many cases the gift cards can only be redeemed at the issuer's establishment, ensuring that the money spent on the gift card is used to purchase the issuer's goods, and is an effective way to get customers into their stores. The cards can also have advertisements, store information, and other useful information on the card that the issuer can use to advertise its business. The cards are easy to use, make good gifts, and can be discarded when depleted. For this application, the term “gift card” is to be understood as any card having either a magnetic strip, printed information, NFC, barcode, or other insignia that is used to store or reflect a designated value, or any other flexible thin card that is used in secure commerce.

These cards provide a very space-efficient manner to stock arcade games. Unlike plush toys and typical prizes, hundreds of secure cards can be stored in even a modest amount of space. However, unlike other types of prizes that can reside without support, prizes in the form of cards will typically be retained in a columnar structure to preserve an orientation and accessibility of the cards. As the cards are won by the players, the stack of cards will be depleted and thus require constant refilling of the stacks of cards by the proprietors of the games. The need for continuous monitoring and refilling of the cards defeats the purpose of a prize that is compact and can store many hundreds of prizes in one game. The present invention is directed to this situation.

### SUMMARY OF THE INVENTION

The present invention is an arcade game based on crane technology, but uses a vacuum extraction device to extract gift cards from a stored collection of cards. In one embodiment, the player aims the extraction device in line with an opening in the silo, which can vary in size and shape to affect the skill needed for extraction and the size of the prize. In an alternative device, the acquisition of the card is related to the play of the game only as the result of a successful play. In the present invention, the gift cards are stored in the blank state, meaning they have no value associated with them. Once the prize is won, the card is delivered to a card writing apparatus that writes a value to the card on its magnetic strip for example. The card, now having a worth commensurate with the value written into the card's magnetic strip, is delivered to the player via a retrieval bin or slot.

As the cards are removed from the stack, the present invention uses a lift device with a drive system that uses a sensor to raise the stack of cards toward the opening of the silo as the cards are won, ensuring accessibility of the stack up to and until the last card is won. The lift system for the cards ensures that the game's operator does not need to monitor the game's card supply until the cards are almost completely depleted, saving time and service. The device that raises the cards includes a switch or sensor, such as an optical sensor, that determines whether the stack of cards has fallen below a predetermined elevation, and signals for the drive component to raise the stack to the designated position in the silo. As cards are removed by successful players, the sensor detects the absence of cards and sends a signal to a processor tasked with actuating a drive system such as a gear motor. Once the stack is raised to the predetermined location, the sensor sends a signal to disengage the drive system and the game is ready for play.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is an elevated perspective view of a game showing the silo and extraction device;

FIG. 2 is an elevational view of the extraction device of the embodiment of FIG. 1;

FIG. 3 is a cross-sectional view of the extraction device and silo of gift cards;

FIG. 4 is an elevational view of the silo with a lift mechanism and drive system to raise the stack of cards;

FIG. 5 is a side view in cross section of the silo and lift mechanism of FIG. 4;

FIG. 6 is an enlarged, retention device to prevent multiple cards from being removed;

FIG. 7 is an elevated perspective view of the retention mechanism of FIG. 6; and

FIG. 8 is a side view in cross section of the silo and extraction device with the lift mechanism where the cards are raised to the top of the card container.

### DETAILED DESCRIPTION OF THE PREFERRED EMBODIMENTS

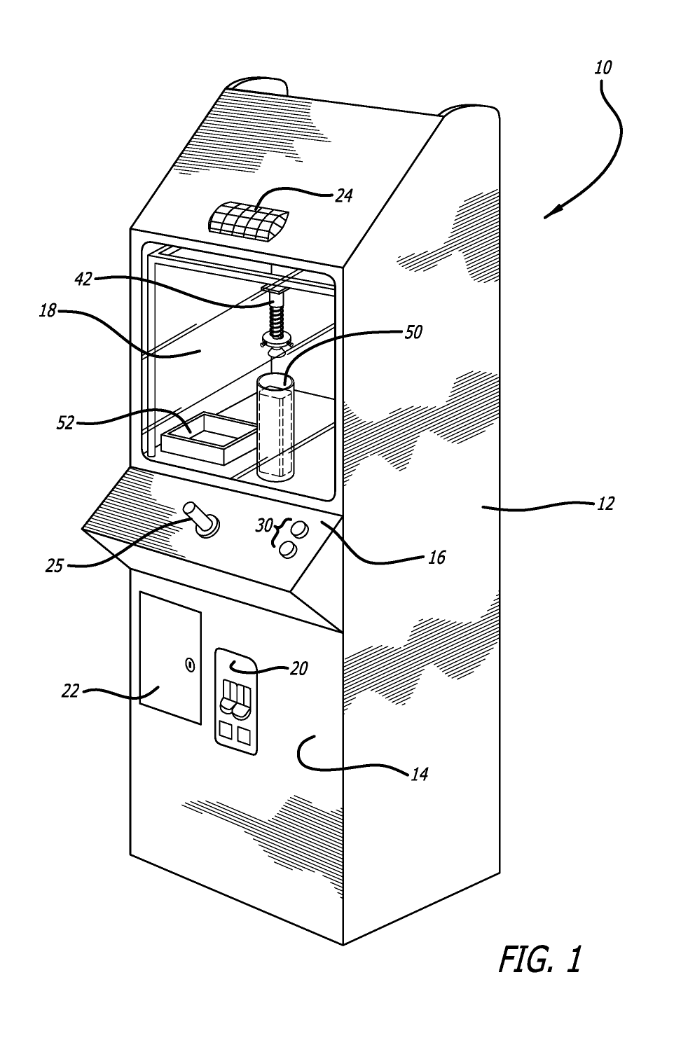

FIG. 1 is a perspective view of one embodiment of a game apparatus 10 in accordance with the present invention. Game apparatus 10 includes a housing 12, front panel 14, and a playing area 18. Housing 12 provides a support for the other components of the game apparatus. Housings can take a wide variety of forms; for example, as shown in FIG. 1, housing 12 may be of the stand-up variety in which a player stands in front of the game or sits on a stool when playing the game. In other embodiments, other types of housings may be provided. For example, a counter-top housing, including approximately the upper half of housing 12 shown in FIG. 1, can be used when the game apparatus 10 is desired to be placed on a table, counter top or other similar surface.

Front panel 14 includes a player control panel 16 that includes player controls 30. Front panel 14 includes a coin deposit slot 20, and a speaker 24 may also be provided on the housing 12. Coin deposit slot 20 may be more generally thought of as a payment area, where the game can accept payment in the form of currency, coins, game tokens, bills, tickets, and the like. In some embodiments, other types of monetary input may also be provided using a magnetic card reader to read a card with a magnetic strip, NFC Tag, barcode, or some secure item that holds game credit information, or a bank card such as a credit card, debit card, etc. A token deposited in coin deposit slot 20 (or other payment method) starts a game. Dispenser compartment 22 is used to provide access to the retrieval bin 52 in the event of a successful attempt by the player.

Speaker(s) 24 can emit sounds based on game actions and other game states and is controlled by a game control system as described subsequently. Flashing lights and other visual attractions are commonly found in these types of games as well. Player control panel 16 allows a player to manipulate events in the game, and includes player controls 30 such as an actuation device such as a push button to initiate the movement of the extraction device. Alternatively, the position of the starting point for the extraction device in the two dimensional X-Y vertical plane can be controlled by a joystick 25, roller ball, touchscreen, or other input device. Game action occurs in playing area 18, where a vacuum extraction device is moved in the playing area 18 using the joystick 25 or other controller device. The extraction device 42 is first moved in a horizontal plane above the playing area the player using the player controls and joystick 25 where the prizes/gift cards are located, and the skill involved is the precision with which the player can accurately control the placement or movement of the extraction device 42.

At the bottom of the playing area 18 is a cylindrical column or silo 50 and the game can include multiple such silos. Each silo 50 includes an enclosure formed by a wall that defines a target area, and houses a stack of cards 51 such as gift cards, redemption cards, or other thin, flat smooth surfaced prizes. The target area formed by the silo wall is dimensioned so as to be slightly larger in the radial direction than the largest dimension (e.g., a diameter) of the extraction device 42. Thus, only by precisely hovering the extraction device 42 over the silo's target area can the player then successfully lower the extraction device into the silo 50 to extract a gift card 51.

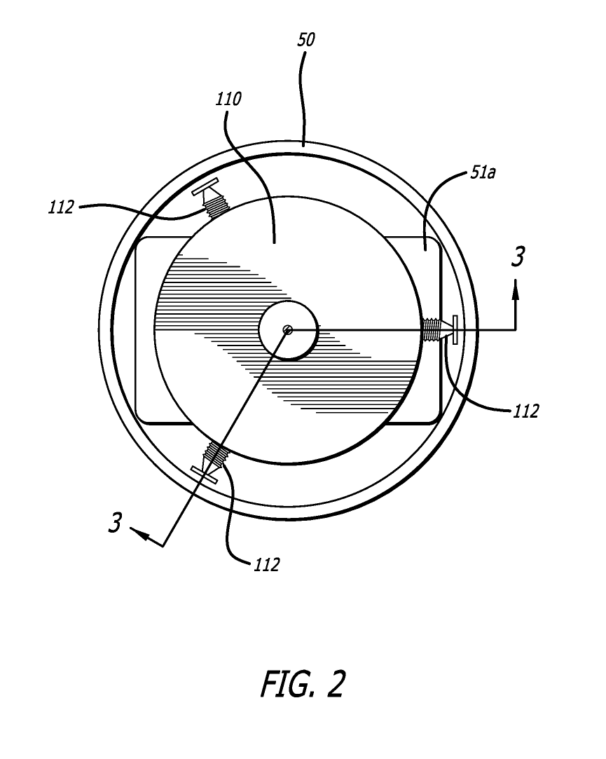

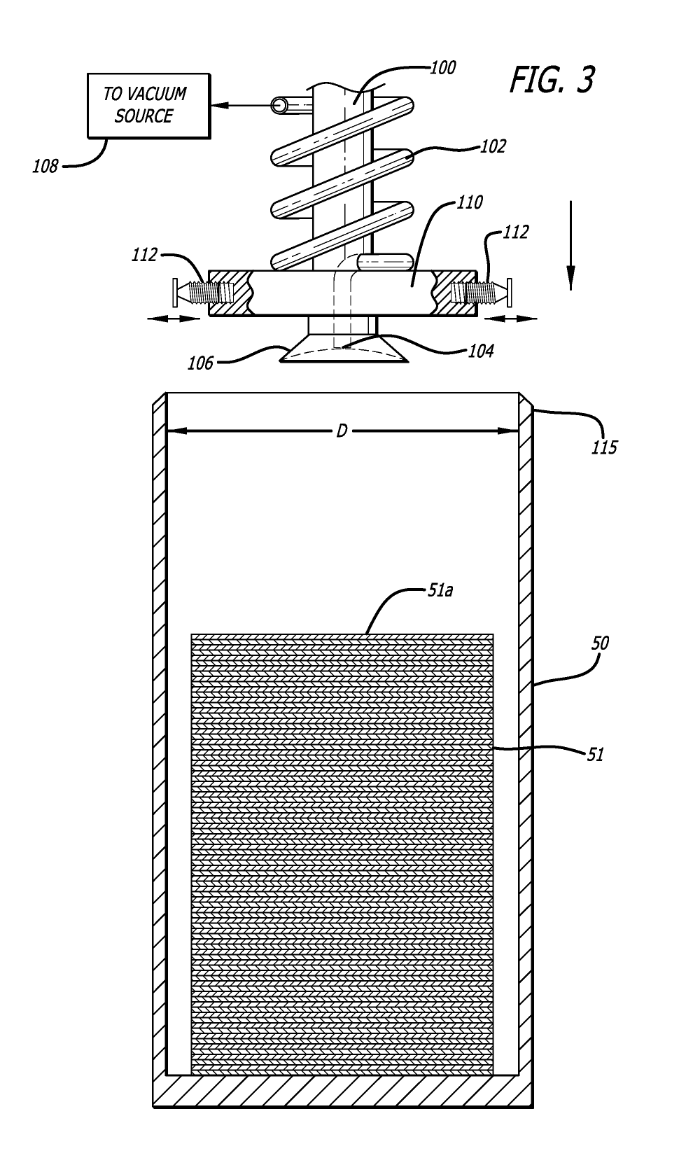

FIGS. 2 and 3 illustrate the extraction device in more detail. A cylindrical rod 100 is connected to a motorized system for controlling the horizontal and vertical movement of the extraction device. A tube 102 is connected at a first end to a vacuum source 108 for creating a negative pressure in the tube 102, and a second end 104 terminates at a suction cup 106 with a flexible periphery. The position of the rod 100 is controlled by a motor, which in turn is controlled by a processor. The processor interprets movement by the joystick 25 or other player controls and converts the joystick movements to a movement of the rod 100. In one preferred embodiment, mounted on the rod is a block 110, which may be cylindrical or it may have other profiles. The block 110 has a width that is less than the inner diameter “D” of a silo 50 housing a stack of cards 51. The player must attempt to drop the extraction device into the silo 50 so that the suction cup 106 makes contact with the upper card 51a in the stack of cards 51. The vacuum source 108 communicates the negative pressure in the tube 102 to the suction cup 106, allowing the suction cup 106 to adhere to the upper card 51a. Once the pressure is applied, the processor automatically lifts the extraction device vertically and moves the extraction device to a position over the retrieval bin 52. At this point, the processor sends a command to the vacuum source 108 to turn off the vacuum pump and activate the relief valve, releasing the gift card 51a from the adherence of the suction cup 106. The gift card or other type of prize will then fall into the retrieval bin 52, where it can be collected by the player.

To increase the difficulty of the game, the block 110 can be equipped with radial projections 112 that increase the width of the block 110. The radial projections 112 are preferably threaded so that they can be extended and inserted into the block 110 at a desired depth. As the radial projections extend the width of the block 110 to approximate the diameter D of the silo 50, the game becomes more challenging and more difficult to win. The radial projections and the amount of extension can be tied to the value of the gift cards, so that the more valuable the cards/prizes, the closer the width of the radial projections approximate the diameter D of the silo 50. The ability to adjust the difficulty of the game also allows younger players to play the game with larger tolerances, making the game more versatile for a greater range of player's abilities. Once the difficulty of the game has been set the play and skill level is the same for all players, young and old.

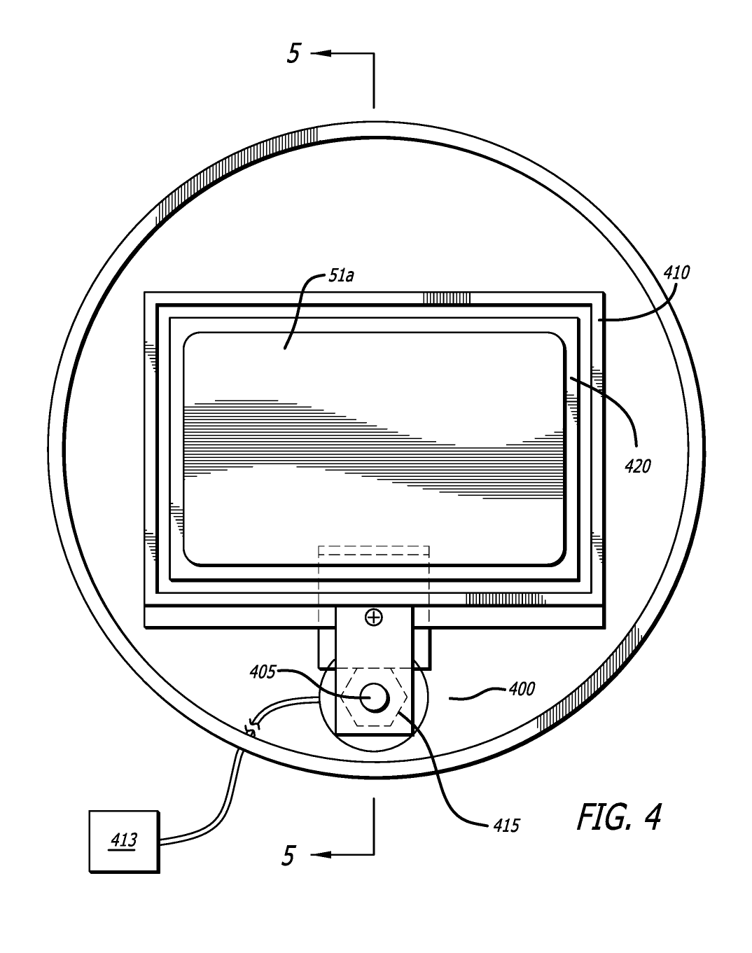

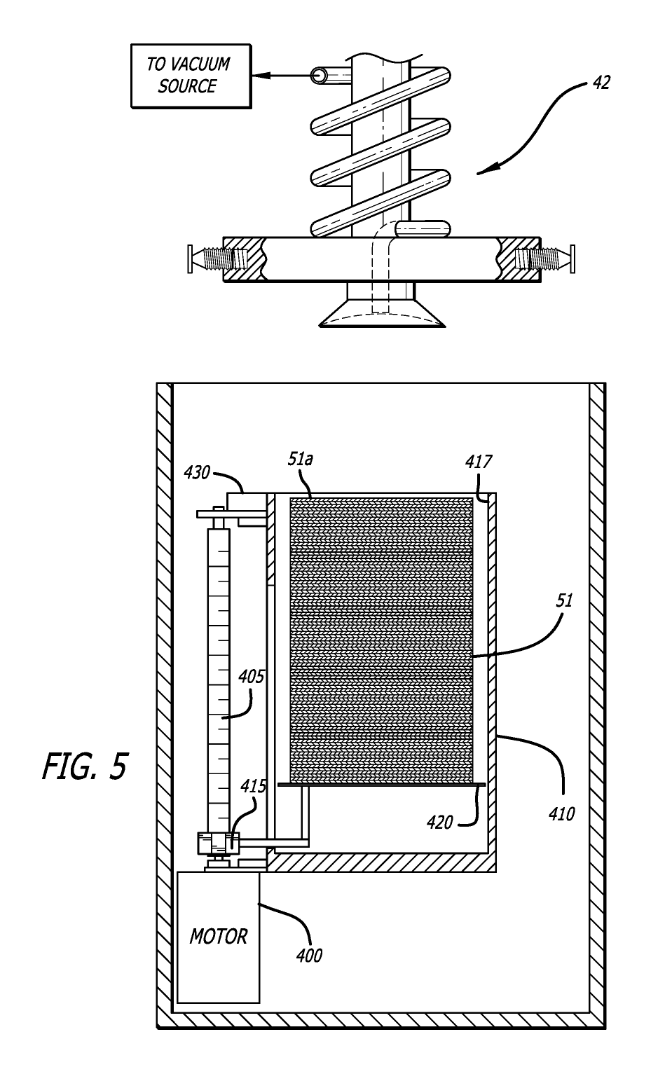

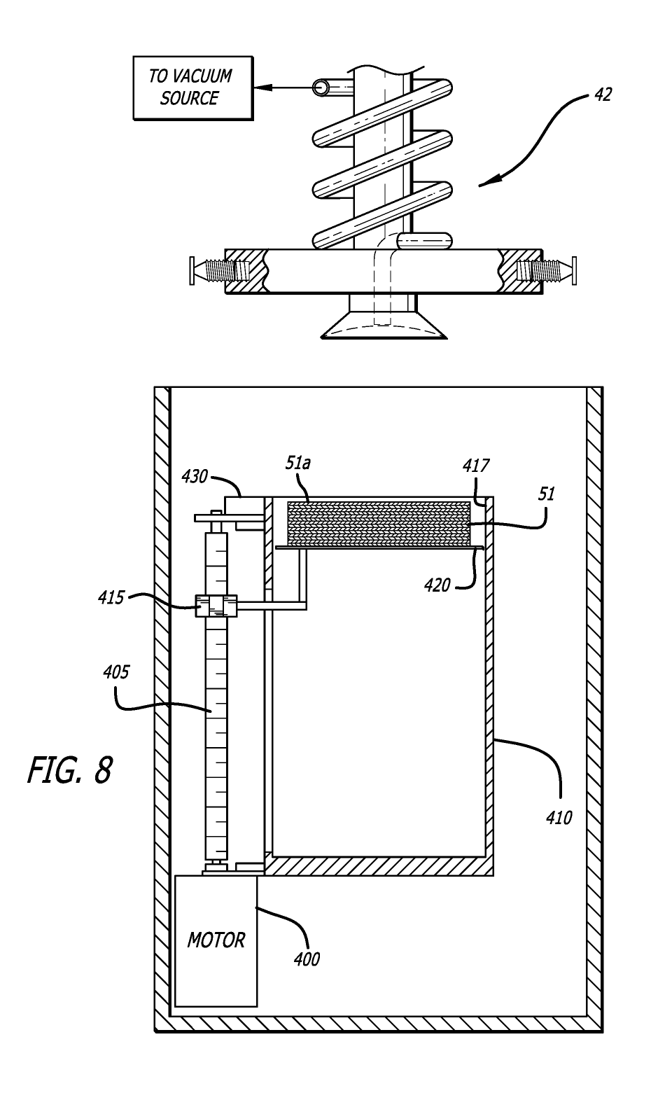

FIGS. 4 and 5 illustrates an alternate embodiment wherein a motorized card stack displacement unit automatically moves the stack of cards toward the opening of the silo. As can be appreciated from the description of FIGS. 2 and 3, after a period the stack of cards will diminish as players win cards from the silo 50. At some point, either the player will no longer be able to see the cards, or the pick-up device may not reach the stack of cards 51. These changes in the height of the prizes results in the game not being attractive to players. The displacement unit of FIGS. 4 and 5 eliminates this issue by continuously raising the stack of cards to be approximately disposed at the top of the silo. This displacement unit can take the form of an electrical motor 400 mounted to a card housing 410 having an electrical cable 411 that is connected to the game's electrical current supply 413. The motor 400 is coupled to a threaded shaft 405 vertically aligned with the outer surface of the card housing 410. The threaded shaft 405 includes a lug 415 that is connected to a platform 420 below the stack of cards. The lug 415 is threadedly engaged with the shaft 405, such that rotation of the shaft 405 raises or lowers the platform 420, depending on the clockwise or counterclockwise rotation of the shaft, in a direction parallel to the axis of the threaded shaft 405. That is, the lug/platform operates like a worm gear on the threaded shaft 405 to move the platform 420 from the bottom of the card housing 410 (FIG. 5) to the top (FIG. 8) and back down, depending upon the rotation of the threaded shaft 405. Rotation of the threaded shaft 405 is driven by the electrical motor 400, such that the motor 400 can accurately place the position of the platform 420 within the card housing 410 by virtue of the precise rotation of the threaded shaft 405. When the stack of cards 51 is placed on the platform 420, the uppermost card 51a on the stack is determined by the location of the platform and the number for cards in the stack. As cards are removed from the stack 51 by successful players, movement of the platform 420 toward the opening 417 of the card housing 410 can preserve the position of the uppermost card 51a in the stack of cards. Accordingly, the pick-up device 42 or extraction device can always acquire the uppermost card of the stack within the card housing and the top of the stack of cards 51 will always be in view of the player.

The displacement unit preferably fits inside the silo 50, which can be of any size. Smaller prizes, such as gift cards, baseball cards, or the like, can be stacked in smaller silos, whereas DVDs, DCs, postcards or larger prizes can be located in larger silos. The extraction device 42 can remain the same, changing only the projections 112 on the block 110. The game could even be enlarged for posters or much larger prizes.

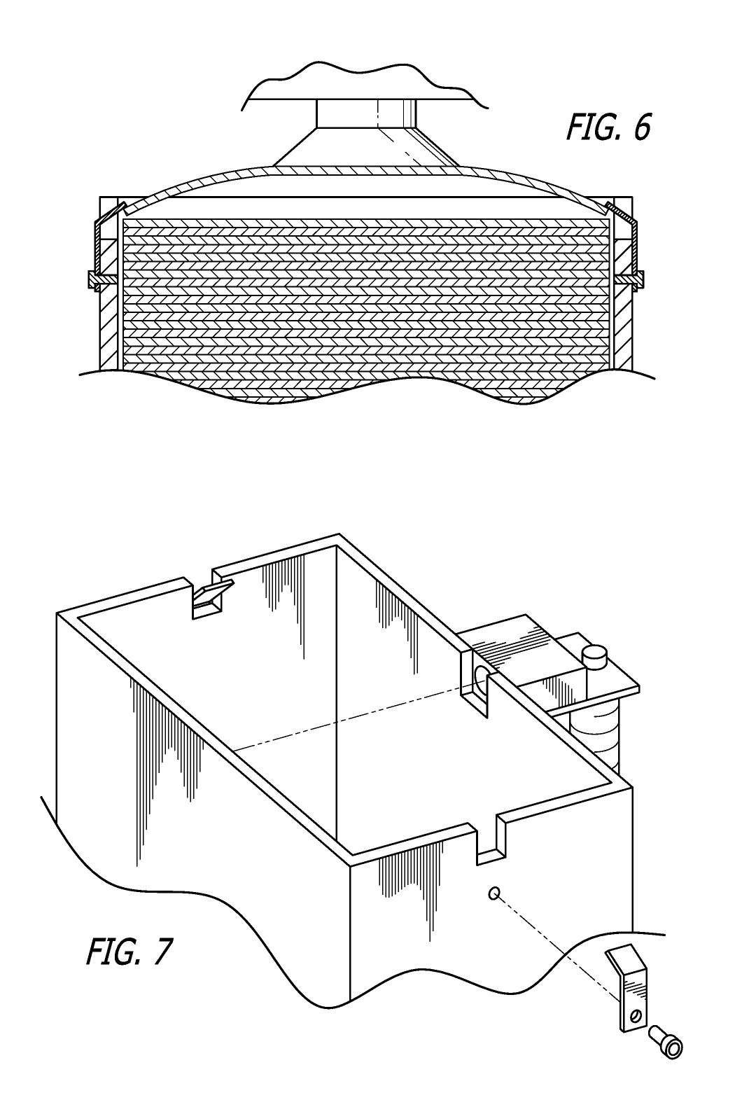

As shown in FIG. 6, the top 417 of the card housing 410 may be equipped with a gate in the form of, for example, a pair of clips 505 held in place in the card housing by pins 510. The clips 505 have an angled upper portion 515 that extends through a slot 520 in the edge of the card housing and above an uppermost card 51a, such that when the uppermost card 51a is removed it comes in contact with the clips 505 at the angled upper portion 515 (see FIG. 6). The contact causes the card 51a to temporarily deform in shape by bowing slightly to fit between the clips 505, or the clips may bend to accommodate stiffer prizes. These clips assist in separating any stuck or attached second cards that may have clung to the uppermost card 51a through static electrical charge or other attractive force. In this manner, the clips 505 prevent the pick-up device 42 from accidentally removing multiple prizes.

To actuate the motor 400, in a preferred embodiment the card housing 410 includes an optical sensor or switch 430 (FIG. 7) at the upper edge of the housing 410. The optical sensor 430 detects the presence or absence of the cards 51 (now shown in FIG. 7 for clarity) by bouncing a beam of light off the stack of cards and receiving a reflection of the light. If a reflection is received, this is interpreted as the card level at least reaching the position of the sensor. If no reflection is received, then this is interpreted as the stack residing below the level of the sensor 430. If the reflection is received by the sensor 430, then no action is needed by the motor 400. Conversely, if no reflection is received, then the motor 400 must rotate the threaded shaft 405 until the platform 420 raising the stack of cards to a position such that the uppermost card 51a is at least at the level of the sensor 430. Once the motor 400 elevates the platform to this level, the sensor 430 will receive the reflection off the stack of cards 51 and disengage the motor 400. In this manner, a level for the cards can be maintained at all times without monitoring by the game's proprietor, as long as there are at least a few cards in the housing sufficient to create a reflection off their collective side surfaces.

As one skilled in the art will appreciate, there are many modifications and alterations to the just-described embodiments that would be readily apparent to those skilled in the art, and such modifications and alterations are intended to be included within the scope of the invention. Accordingly, the invention should not be construed or limited to those just described embodiments, which are illustrative but not exclusive, but rather the scope of the invention should be determined by the words of the claims appended below using those words common and ordinary meanings within the context of the embodiments described above.

1. An arcade game, comprising:
a housing including player controls and a window in said housing for viewing action within the housing;
a plurality of cards stored in a card housing;
a silo surrounding the card housing;
an extraction device for extracting a first gift card from the plurality of cards in silo;
a card displacement mechanism for moving a stack of cards inside the silo such that as cards are removed through game play, an uppermost card in the stack of cards is maintained at a constant position with respect to an upper edge of the silo; and
a sensor for determining a presence of a card at the constant position.

2. The arcade game of claim 1, wherein the sensor is an optical sensor.

3. The arcade game of claim 2, wherein the displacement mechanism is a motor driven shaft and a platform mounted on the shaft.

4. The arcade game of claim 3, wherein the motor driven shaft and the platform operate like a worm gear.

5. The arcade game of claim 1, wherein the vacuum member is a suction cup.

6. The arcade game of claim 1, wherein an object of the arcade game is to extract a first card from the plurality of cards using the extraction device.

7. The arcade game of claim 1, wherein the card housing includes a gate for limiting the extraction device to picking up a single card.

8. The arcade game of claim 7, wherein the gate comprises a pair of clips having an angled upper portion to engage an uppermost card as it is being extracted by the extraction device to temporarily deform a shape of said uppermost card.
